(19) United States
(12) Patent Application Publication
(10) Pub. No.: US 2009/0251272 A1
(43) Pub. Date: Oct. 8, 2009

(54) INDUCTOR

(75) Inventors: Yuki SATAKE, Tokyo (JP); Tsutomu SATO, Kanagawa (JP); Shigeki TERATANI, Tokyo (JP)

Correspondence Address: HOSOON LEE, 9600 SW OAK ST. SUITE 525, TIGARD, OR, 97223, US

(73) Assignees: SHINTO HOLDINGS CO., LTD., Tokyo (JP); TMP CO., LTD, Yamato-shi (JP)

(21) Appl. No.: 12/420,048

(22) Filed: Apr. 7, 2009

(30) Foreign Application Priority Data
Apr. 8, 2008 (JP) 2008-100849

(51) Int. Cl. H01F 17/04

(52) U.S. Cl. 336/221

(57) ABSTRACT

An inductor includes a magnetic core having high permeability or high saturation property; and a coil element embedded in the magnetic core, wherein the magnetic core has a polygon, with 5 or more, pillar shape.

The present invention claims the benefit of Japanese Patent Application No. 2008-100849, filed in Japan on Apr. 8, 2008. which is hereby incorporated by reference for all purposes as if fully set forth herein.

### BACKGROUND OF THE INVENTION

1. Field of the Invention

The present invention relates to an inductor, and more particularly, to an inductor that can reduce leakage of magnetic flux and improve disturbance of magnetic flux.

2. Discussion of the Related Art

There has been need for development of inductors having excellent low loss property and DC (direct current) bias property in the field of various electronic devices, such as an AV device and an information processing device, a lightning circuit, such as a discharge lamp, and the like. As an inductor coping with this need, provided is a choke coil with a coil element embedded in a magnetic core by disposing an insulation coated ferromagnetic metal powder and a coil element in a mold and performing a press forming, as described in Japanese Patent Application Publication No. 2006-13066.

Alternatively, since leakage of magnetic flux from an inductance element occurs and thus radiation noise is given to an external Circuit element, as an inductance element which reduces radiation noise, provided is an inductance element with about a spherical magnetic core in external shape as described in Japanese Patent Application Publication No. 2005-109399.

Alternatively, as described in Japanese Patent Application No. 2006-283118 which was filed by the Applicant for the present Application, provided is an inductor with a coil element integrally embedded in a magnetic core by disposing an insulation coated magnet powder and a coil element in a mold and performing a press forming, wherein the inductor is spherical.

The inductor disclosed in Japanese Patent Application Publication No. 2006-13066 has highly excellent DC bias property. However, since the magnetic core is rectangular in shape, a dead space is made in a mounting space, and decreasing a mounting area is thus limited. Moreover, when the magnetic core encapsulating the coil element is rectangular, a magnetic flux is subject to leak from a core edge portion. Accordingly, it is concerned that a peripheral circuit element is affected by secondary radiation and mal-operation is thus caused.

Since the inductor disclosed in Japanese Patent Application No. 2006-283118 is a magnetic core of a spherical structure, there are excellent advantages of leakage of magnetic flux and disturbance of magnetic flux hardly occurring and remedying a problem that an unnecessary dead space is made when embedded on a circuit board. However, since it is necessary that two extracting 4 ends of a coil conductive wire extend to the outside of the core to configure connecting terminals, cost is taken in production.

### SUMMARY OF THE INVENTION

Accordingly, the present invention is directed to an inductor that substantially obviates one or more of the problems due to limitations and disadvantages of the related art.

An advantage of the present invention is to provide an inductor that can greatly reduce radiation noise and also effectively use a mounting space and be easier and take less cost in production than a spherical core.

Additional features and advantages of the present invention will be set forth in the description which follows, and in part will be apparent from the description, or may be learned by practice of the invention. These and other advantages of the invention will be realized and attained by the structure particularly pointed out in the written description and claims hereof as well as the appended drawings.

To achieve these and other advantages and in accordance with the purpose of the present invention, as embodied and broadly described herein, an inductor includes a magnetic core having high permeability or high saturation property; and a coil element embedded in the magnetic core wherein the magnetic core has a polygon, with 5 or more, pillar shape. Since base surfaces of the polygon pillar has a regular polygon with 5 or more and the magnetic core has a polygon pillar as a basic shape, there are following effects. First, since each angle of the regular polygon with 5 or more is more than 90 degrees. effect of reducing occurrence of magnetic flux leakage increases. Moreover, for example, in case of a cylinder shape, there is a problem, in an aspect of mounting, that a useless space occurs in view of configuration with other electronic components but by using the polygon pillar, such the problem can be reduced. In other words, the useless space can be eliminated, and thus, in an aspect of mounting, handling is easy, thus manufacturing is easy.

The inductor, wherein an edge made between one base surface and a side surface has a curve shape with a predetermined curvature, can be used. Since the polygon pillar has a pair of a top base surface and a bottom base surface which are parallel to each other and have a regular polygon, there exist an edge made between one base surface and a side surface and an edge made between the other base surface and the side surface. At least one edge has a curve shape. Having a curve shape with a predetermined curvature means that an entire portion of the edge along a circumference of the base surface is curved to a substantially equal extent. By forming this shape, leakage of magnetic flux and disturbance of magnetic flux can be reduced. When making an edge of a side surface, which is substantially not affected by leakage of magnetic flux, not curved. production cost can be reduced.

The inductor, wherein an edge between one base surface and a side surface has a curve shape with a predetermined curvature, and additionally, an edge between the other base surface and the side surface has a curve shape with a predetermined curvature, can be used. In this inductor, the edge between the one base surface and the side surface and the edge between the other base surface and the side surface all have a curve shape. By increasing portions which have a curve shape, leakage of magnetic flux and disturbance of magnetic flux can be more reduced. It is permissible that the curve shape of the edge between the one base surface and the side surface is different in curvature from the edge between the other base surface and the side surface. By making the different curvature, a direction of a magnetic flux can be changed into a direction in which an influence by the magnetic flux is less.

The inductor, wherein a curve of an edge between one base surface and a side surface has the same curvature as a curve of an edge between the other base surface and the side surface, can be used. In this inductor, it is requisite that a curvature of the curve of the edge between the one base surface and the side surface is the same as a curvature of the curve of the edge between the other base surface and the side surface. Accordingly, leakage of magnetic flux and disturbance of magnetic flux can be more reduced.

The inductor, wherein all edges thereof have a curve shape, can be used. In this inductor, in addition to that an edge between one base surface and a side surface and an edge between the other base surface and the side surface all have a curve shape, edges of the side surface have a curved shape, and as a result, all edges have a curve shape. A magnetic core functions as a yoke of a coil element. Also, the magnetic core functions as a magnetic shield component shielding the external of a coil element since the magnetic core extends along a magnetic path of a magnetic flux produced from the coil element. Accordingly, a strong magnetic shield effect for an external element is achieved. Since all edges of the inductor have a curve shape, a portion which a magnetic flux are emitted from has a curve shape, thus there is a remarkable effect that leakage of magnetic flux can be reduced and disturbance of magnetic flux does not occur. The present invention actively uses a characteristic effect of an inductor which is provided with a coil element embedded in a magnetic core. This type of inductor is manufactured by disposing an insulation coated magnet powder and a coil element in a mold and performing a press forming. Therefore, the inductor has a structure of the coil element integrally embedded in the magnetic core of high permeability or high saturation property.

An inductor including a magnetic core having high permeability or high saturation property and a coil element embedded in the magnetic core, wherein the magnetic core has about a cylinder shape, and a side surface of the cylinder has a curve shape which expands in a horizontal direction, can be used. In this inductor, since the magnetic core has a curve shape which expands in a horizontal direction, leakage of magnetic flux and disturbance of magnetic flux can be reduced. Moreover, the magnetic core is not spherical but has a plane portion, it is easy to install/be equipped with a connection terminal. In other words, an end portion of a copper line of the coil element embedded inside protrudes on the plane portion of the core and becomes the connection terminal. Accordingly, compared with a spherical shape, production processes are reduced.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1A is a view illustrating an inductor according to a first embodiment of the present inventions

FIG. 1B is a view illustrating an inductor according to a first embodiment of the present invention;

FIG. 2A is a view illustrating an inductor according to a first embodiment of the present invention;

FIG. 2B is a view illustrating an inductor according to a first embodiment of the present invention,

FIG. 3 is a view illustrating an inductor according to a first embodiment of the present invention;

FIG. 4A is a view illustrating an inductor according to a second embodiment of the present invention:

FIG. 4B is a view illustrating an inductor according to a second embodiment of the present invention;

FIG. 5A is a view illustrating an inductor according to a third embodiment of the present invention;

FIG. 5B is a view illustrating an inductor according to a third embodiment of the present invention:

FIG. 6A is a view illustrating an inductor according to a fourth embodiment of the present invention; and

FIG. 6B is a view illustrating an inductor according to a fourth embodiment of the present invention.

### DETAILED DESCRIPTION OF THE ILLUSTRATED EMBODIMENTS

Reference will now be made in detail to illustrated embodiments of the present invention, which are illustrated in the accompanying drawings.

### First Embodiment

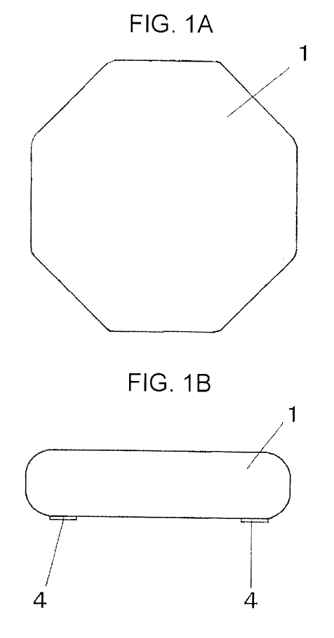

FIGS. 1 to 3 show an inductor according to a first embodiment of the present invention. FIG. 1 shows an external appearance of the inductor according to the first embodiment Of the present invention. FIG. 1A is a top view illustrating the inductor, and FIG. 1B is a side view illustrating the inductor. The inductor according to the first embodiment has an octagon pillar shape, and all edges of the octagon pillar are curved. Alternatively at least one edge of the octagon pillar may be curved. The octagon pillar has top and bottom base surfaces and a side surface. Top and bottom base surfaces are substantially octagonal. For examples the top and bottom base surface are substantially regular octagonal. The side surface includes first to eight sub-side surfaces configured along a circumference of the octagon pillar. The first to eight sub-side surfaces are substantially rectangular.

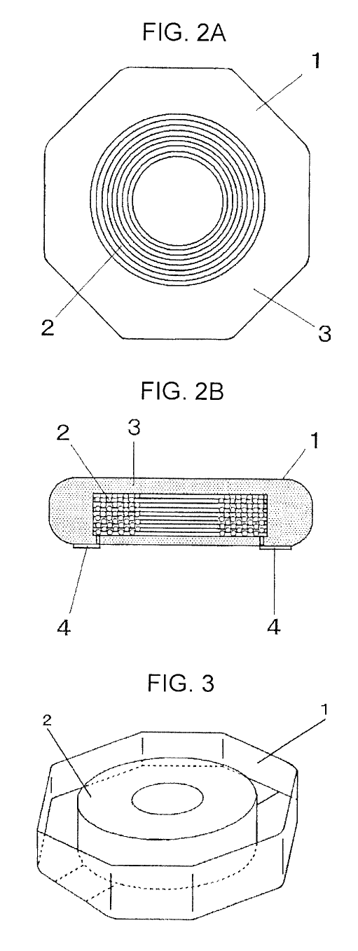

FIG. 2 is a view illustrating configuration of a coil element integrally embedded in a magnetic core of the inductor according to the first embodiment of the present invention. The coil element 2 is embedded in the magnetic core 1 except for both end portions of the coil element 2. The both end portions protrude from the bottom portion of the core 1 to the outside of the magnetic core 1 and are bent sidewardly along the bottom base surface of the magnetic core 1. The both end portions 4 of the coil element 2 along the bottom base surface of the magnetic core 1 may be used as connection terminals. Insulating layer of the connection terminals is removed and is reflow soldered to a printed wire of a printed circuit board (PCB). Accordingly. the inductor of the first embodiment is mounted as a surface mount component on the PCB.

The inductor according to the present invention is formed by disposing an insulation coated magnet powder and the coil element 2 in a mold and performing a press forming process. The magnetic core 1 has the octagon pillar in external shape and at least one edges of the octagon pillar may have a curve shape. For example, all edges of the octagon pillar are curved. In the present invention edges of the octagon pillar may be for example portions made between the top base surface and the side surface or the top base surface and the sub-side surfaces between the bottom base surface and the side surface or the bottom base surface and the sub-side surfaces. and between adjacent sub-side surfaces.

The magnetic core 1 shields the external of the coil element 2 embedded in the magnetic core. Accordingly, the magnetic core 1 comprises a core which has a magnetic shielding effect of shielding a magnetic flux produced from the coil element 2 and a yoke formed in an inner space 3 of the coil element 2. The coil element 2 may be referred to as an air core coil which is made by winding a copper wire covered with urethane and the like.

In the inductor of the first embodiment, since all edges of the magnetic core 1 are curved, the problem that disturbance of magnetic flux occurs can be greatly improved. Moreover, radiation noise due to leakage of magnetic flux can be reduced.

A method of manufacturing the inductor according to the present invention is as follows. The inductor is manufactured by performing a press forming for an insulation coated magnet powder and a coil element and grinding edges of the inductor to make those curved. In case of mass production, the grinding process may be eliminated, and the press forming process may be performed using a frame corresponding to the final shape of the inductor. For example, before or during the press forming, edges of the inductor may have a curve shape. Alternatively, the inductor is manufactured by performing a press forming for a mix powder of an electrically-insulating binder and a high permeability magnet powder, and a coil element.

The magnet powder may use one magnet metal or more, for example, of iron, iron silicide, carbonyl iron, supermalloy (Fe-Ni-Mo), permalloy (Fe-Ni), sendust, iron-aluminum alloy, iron nitride, iron-cobalt alloy and the like. As an insulating material or insulating binder coating the magnet powder, various inorganic insulating materials, for example, silicon oxide and the like, or various organic insulating materials may be used. To be concrete, for example, it is selected from silicon oxide, water glass, silicon resin, phenolic resin, exposy resin and the like.

### Second Embodiment

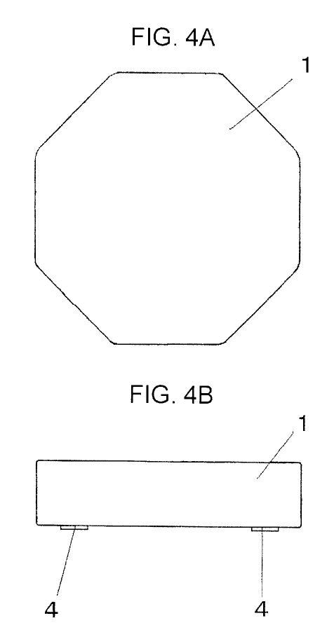

FIG. 4 shows an external appearance of an inductor according to a second embodiment of the present invention. FIG. 4A is a top view illustrating the inductor, and FIG. 4B is a side view illustrating the inductor. The external appearance of the inductor has an octagon pillar. Edges of the inductor may not have a curve shape.

### Third Embodiment

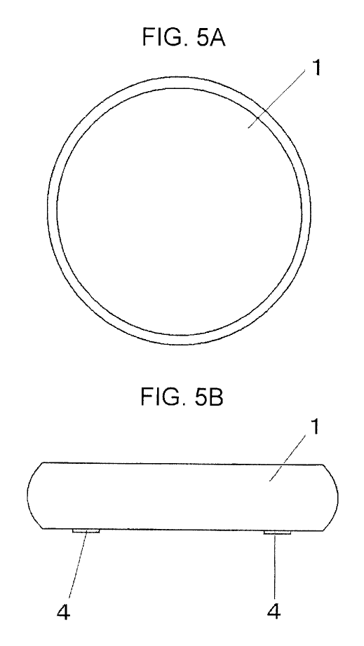

FIG. 5 shows an external appearance of an inductor according to a third embodiment of the present invention. FIG. 4A is a top view illustrating the inductor, and FIG. 4B is a side view illustrating the inductor. The external appearance of the inductor has about a cylinder shape. A side surface of the inductor may have a curve shape which expands outwardly in horizontal direction.

### Fourth Embodiment

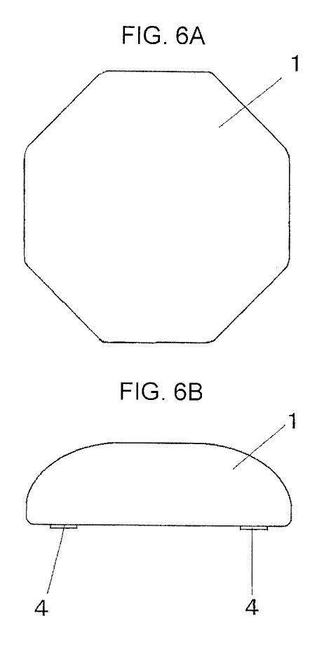

FIG. 6 shows an external appearance of an inductor according to a fourth embodiment of the present invention. FIG. 6A is a top view illustrating the inductor, and FIG. 6B is a side view illustrating the inductor. The external appearance of the inductor has an octagon pillar. An edge between a top base surface and a side surface is curved, and an edge between a bottom base surface and the side surface is curved. A curvature of the edge around the top base surface may be different from a curvature of the edge around the bottom base surface.

In the first, second and fourth embodiments, the inductor having an octagon pillar shape are mainly explained. However, it should be understood that the inductor can have other polygon pillar shape, for example, polygon, with 5 or more, pillar shape.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. An inductor comprising:
a magnetic core having high permeability or high saturation property; and
a coil element embedded in the magnetic core.
wherein the magnetic core has a polygon, with 5 or more, pillar shape.

2. The inductor according to claim 1, wherein an edge between one base surface and a side surface of the polygon pillar substantially has a curve shape with a predetermined curvature.

3. The inductor according to claim 2, wherein an edge between the other base surface and the side surface of the polygon pillar substantially has a curve shape with a predetermined curvature.

4. The inductor according to claim 3, wherein the curvature of the edge between the one base surface and the side surface is substantially the same as the curvature of the edge between the other base surface and the side surface.

5. The inductor according to claim 1, wherein all edges of the polygon pillar substantially have a curved shape.

6. An inductor comprising:
a magnetic core having hill permeability or high saturation property; and
a coil element embedded in the magnetic core.
wherein the magnetic core has about a cylinder shape, and a side surface of the cylinder has a curve shape which expands outwardly.
